(19) United States
(12) Patent Application Publication
(10) Pub. No.: US 2025/0307637 A1
(43) Pub. Date: Oct. 2, 2025

(54) COMPUTER-IMPLEMENTED SYSTEM AND METHOD FOR CREATING A DOMAIN-SPECIFIC LANGUAGE LEARNING MODEL (LLM) WITH AN APPLICATION LOGIC LAYER

(71) Applicant: Gurbaksh Singh Chahal, Hong Kong (HK)

(72) Inventor: Gurbaksh Singh Chahal, Hong Kong (HK)

(21) Appl. No.: 18/617,289

(22) Filed: Mar. 26, 2024

(51) Int. Cl. G06N 3/0895

(52) U.S. Cl. CPC G06N 3/0895

(57) ABSTRACT

Disclosed is a computer-implemented method for constructing a domain-specific language learning model (LLM). The computer-implemented method includes a step of ingesting, from a server, a domain-focused dataset. The computer-implemented method includes a step of assimilating, from a search engine database, a real-time digital data stream. The computer-implemented method includes a step of integrating the domain-focused dataset, and the real-time digital data stream within an application logic layer to obtain an integrated dataset. The computer-implemented method includes a step of employing, by a processor, a transformer algorithm on the integrated dataset to extract a plurality of domain-specific textual insights. The computer-implemented method includes a step of utilizing, by the processor, said domain-specific textual insights to execute one or more business tasks. The computer-implemented method includes a step of presenting both the domain-specific textual insights and the executed business tasks on a user interface.

### TECHNOLOGICAL FIELD

The present disclosure generally relates to the data processing using artificial intelligence and more particularly relates to a computer-implemented system and method for constructing a domain-specific Language Learning Model (LLM) that incorporates an advanced application logic layer for real-time data integration and processing.

### BACKGROUND

The evolving landscape of digital business operations underscores the crucial role of Language Learning Models (LLMs) in facilitating effective communication. However, existing LLMs encounter limitations, particularly in their ability to dynamically adapt to real-time changes and cater to the nuances of specific business domains. This identified gap in the market underscores the necessity for an advanced LLM capable of effortlessly integrating live data feeds and domain-specific knowledge. Such a model would not only bridge the existing gaps in adaptability but also elevate the utility and precision of LLMs in addressing the unique requirements of specialized business applications.

The present disclosure recognizes the limitations and gaps in existing LLMs, particularly their struggles with vast data assets. In light of these considerations, this disclosure recognizes the pressing need for the development of a comprehensive system and method designed explicitly for constructing a domain-specific Language Learning Model (LLM). The objective of the present disclosure is to address the shortcomings observed in current LLMs, providing a solution tailored to the dynamic demands of diverse business domains, thereby enhancing communication and comprehension in specialized contexts.

### BRIEF SUMMARY OF SOME EXAMPLE EMBODIMENTS

Various embodiments are provided herein for the creation of a domain-specific LLM that is fortified with an application logic layer. The application logic layer is designed to assimilate and process both domain-centric and real-time data streams, utilizing a sophisticated transformer algorithm. The insights derived from this data fusion are then applied to execute business tasks, which are subsequently presented to users via an interactive digital interface. The system is engineered to accommodate scalability, integrate user feedback for continuous improvement, and support multilingual processing. It also includes a non-transitory computer-readable medium containing the code necessary to implement the method.

In one aspect, a system for constructing a domain-specific language learning model (LLM) is provided. The system includes a memory and a processor. The memory stores computer-executable instructions. The processor is configured to execute the computer-executable instructions to ingest a domain-focused dataset. The processor is configured to assimilate a real-time digital data stream. The processor is configured to integrate the domain-focused dataset, and the real-time digital data stream within an application logic layer to obtain an integrated dataset. The processor is configured to employ a transformer algorithm on the integrated dataset to extract a plurality of domain-specific textual insights. The processor is configured to utilize the domain-specific textual insights to execute one or more business tasks. The processor is configured to present both the domain-specific textual insights and the executed business tasks on a user interface.

In additional system embodiments, the system includes a communication interface and a search engine database. The communication interface is used for handling API requests. The search engine database supplies the real-time digital dataset in response to said API requests.

In additional system embodiments, the processor includes a Retrieval-Augmented Generation (RAG) model for processing the domain-focused dataset, and the real-time digital data stream and applying a domain-specific answer logic within the LLM.

In additional system embodiments, the processor is configured to manage high request volumes through a microservices architecture, utilizing containerization with Docker and orchestration with Kubernetes for enhanced performance and scalability.

In another aspect, a computer-implemented method for constructing a domain-specific language learning model (LLM) is provided. The computer-implemented method includes a step of ingesting a domain-focused dataset from a server. The computer-implemented method includes a step of assimilating a real-time digital data stream from a search engine database. The computer-implemented method includes a step of integrating the domain-focused dataset, and the real-time digital data stream within an application logic layer to obtain an integrated dataset. The computer-implemented method includes a step of employing a transformer algorithm on the integrated dataset to extract a plurality of domain-specific textual insights by the processor. The computer-implemented method includes a step of utilizing the domain-specific textual insights to execute one or more business tasks by the processor. The computer-implemented method includes a step of presenting both the domain-specific textual insights and the executed business tasks on a user interface.

In additional method embodiments, the method includes a step of incorporating a plurality of additional datasets received from a plurality of data sources to enhance a domain-specific knowledge base.

In additional method embodiments, the method includes a step of integrating user-generated feedback data to refine the LLM and the application logic layer, fostering a dynamic learning environment.

In additional method embodiments, the transformer algorithm is adaptable to process multilingual datasets by applying one or more advanced tokenization techniques to generate the domain-specific insights across a plurality of languages.

In additional method embodiments, the application logic layer is constructed using contemporary development frameworks, such as Node.js and React, and is deployable across major cloud platforms for optimal scalability and reliability.

In additional method embodiments, the transformer algorithm incorporates a Retrieval-Augmented Generation (RAG) approach, enabling the LLM to dynamically integrate pertinent real-time information into its output, thereby enhancing the relevance and accuracy of its responses.

In additional method embodiments, the method includes a step of receiving, by the processor, a plurality of API requests.

In additional method embodiments, the method includes a step of supplying, by the search engine database, the real-time digital dataset in response to the API requests.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described exemplary embodiments of the disclosure in general terms, reference will now be made to the accompanying drawings, which are not necessarily drawn to scale, and wherein:

FIG. 1 illustrates a block diagram showing an example architecture of a system for constructing a domain-specific language learning model (LLM), in accordance with one or more example embodiments.

FIG. 2 illustrates an exemplary block diagram of a system, in accordance with one or more example embodiments.

FIGS. 3A-3B illustrate operational flowcharts of the present system and method, in accordance with one or more example embodiments.

FIG. 4 is a flowchart of a computer-implemented method for constructing a domain-specific language learning model (LLM), in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, and/or stored in accordance with embodiments of the present disclosure. Thus, the use of any such terms should not be taken to limit the spirit and scope of embodiments of the present disclosure.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer-readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network devices, and/or other computing devices.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for constructing a domain-specific language learning model (LLM) with an application logic layer. The present system, method, and computer program product addresses the need for integrating real-time and domain-specific data, offering a more effective and applicable LLM for various business sectors, and providing a competitive edge in the realm of business AI applications.

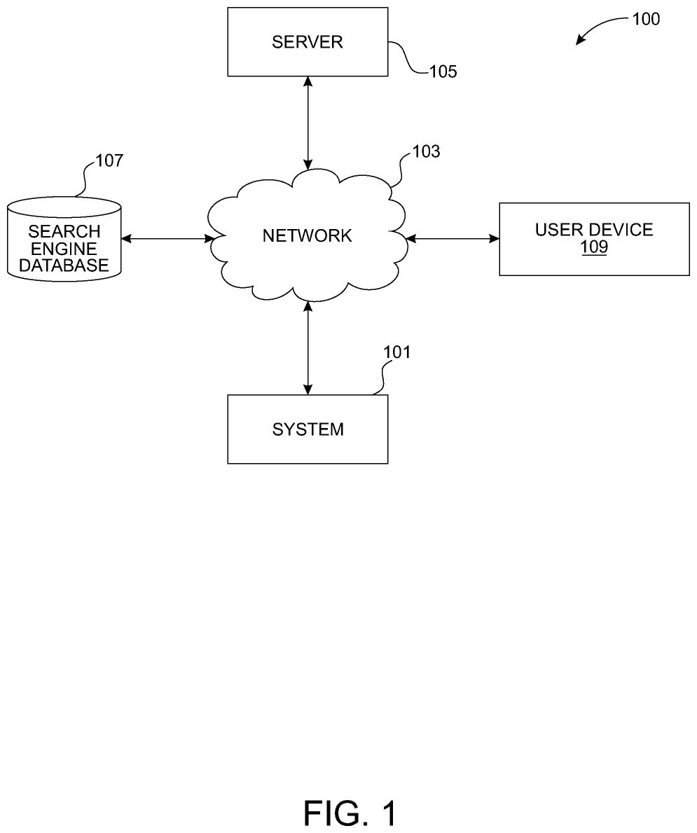

FIG. 1 illustrates a block diagram 100 showing an example architecture of a system 101 for constructing a domain-specific language learning model (LLM), in accordance with one or more example embodiments. As illustrated in FIG. 1, the block diagram 100 may comprise the system 101, a network 103, a server 105, and a search engine database 107. The components described in the block diagram 100 may be further broken down into more than one component such as a mobile application or web application installed in a user device 109 and/or combined in any suitable arrangement. Further, it is possible that one or more components may be rearranged, changed, added, and/or removed without deviating from the scope of the present disclosure.

In various embodiments, the server 105 may collect, import, and process domain-focused datasets for storage, and analysis. In an embodiment, the server 105 may receive the domain-focused dataset from a variety of data sources depending on the applications from the user devices 109 over the network 103. A domain-focused dataset refers to a collection of data specifically curated and tailored for a particular subject or industry. Examples of the domain-focused dataset vary widely depending on the targeted domain. A few examples of various domains include but are not limited to medical domain, financial domain, e-commerce domain, social media domain, education domain, transportation domain, environmental domain, and energy domain. In various embodiments, the user device 109 may be a computer, a database, a smartphone, a mobile phone, a computing device, a tablet, or a laptop. In some embodiments, examples of the applications include but are not limited to 1) a media network wherein the present system may be applied to compose news, identify trends, verify content, create user-tailored content, and provide interview transcription; 2) a B2B marketplace where the present system may be applied to automate client support, vendor integration, product description optimization, market dynamics analysis, and customer acquisition.

In some embodiments, the system 101 may be the server 105 and therefore may be co-located with or within the system 101. For example, the system 101 may be embodied as a cloud-based service, a cloud-based application, a cloud-based platform, a remote server-based service, a remote server-based application, a remote server-based platform, or a virtual computing system. In each of the embodiments, the system 101 may be communicatively coupled to the components shown in FIG. 1 to carry out the desired operations and wherever required modifications may be possible within the scope of the present disclosure.

In various embodiments, the system 101, and the user device 109 are connected over the network 103 for data transmission. The network 103 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The search engine database 107 may store data about the various applications. Data may include multi-media content files, insights data, etc. The search engine database 107 may be communicatively coupled to the server 105. The server 105 may comprise one or more processors configured to process requests received from the system 101. The processor may fetch data from the search engine database 107 and transmit the same to the system 101 in a format suitable for use by the system 101.

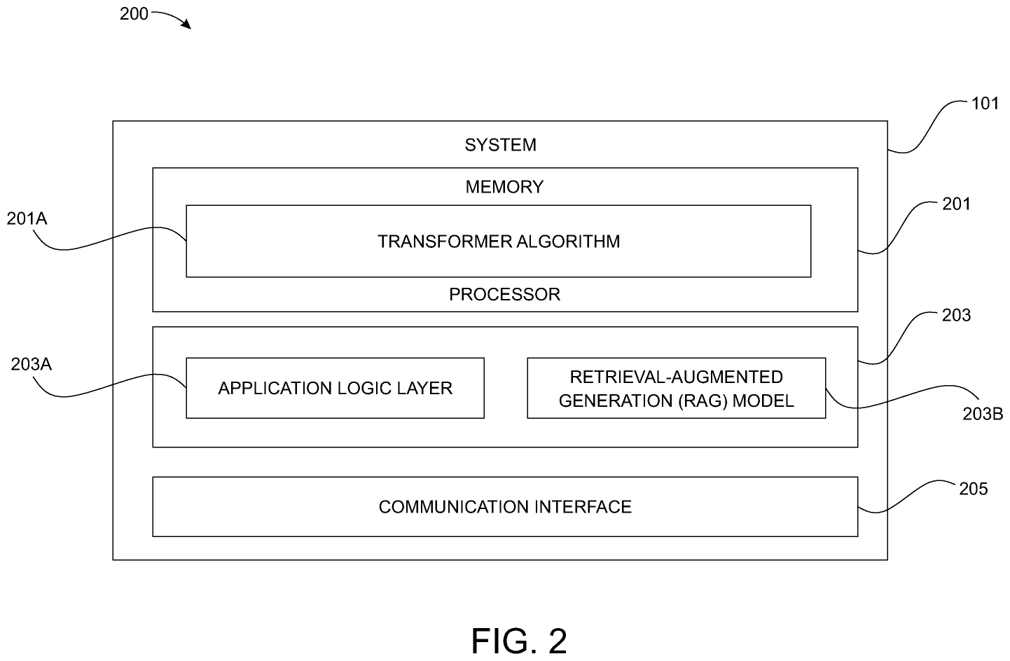

FIG. 2 illustrates an exemplary block diagram 200 of a system 101, in accordance with one or more example embodiments. FIG. 2 is explained in conjunction with FIG. 1. The system 101 includes a memory 201, a processor 203, and a communication interface 205. The memory 201 is configured for storing computer-executable instructions, and a transformer algorithm 201A. The processor 203 is coupled to the memory 201 and executes the computer-executable instructions to ingest a domain-focused dataset. In an embodiment, the domain-focused dataset is augmented with specialized datasets from sources such as a media network (e.g. BNN news) and a B2B marketplace (e.g. Procurenet), achieving linguistic precision finely tuned to contextual subtleties and domain-specific nuances. The processor 203 is configured to assimilate a real-time digital data stream. In an embodiment, the real-time digital data stream is related to various domains. The format of the domain-focused dataset and the real-time digital data stream include but are not limited to textual data, multimodal data, including images, audio, and video. In an embodiment, the processor executes the transformer algorithm to process the integrated dataset to generate domain-specific textual insights. The processor processes the integrated dataset and generate insights from texts, images, audio, and video data related to various domains. This could involve the development of transformer algorithms that can seamlessly integrate and interpret data from different modalities within the same application logic layer. The processor 203 is configured to integrate the domain-focused dataset, and the real-time digital data stream within an application logic layer 203A to obtain an integrated dataset. In an embodiment, the application logic layer 203A is meticulously architected across three distinct strata: a foundational Core Language Modeling layer, an AI Operational Core as the application logic layer, and a Multimodal Interaction Interface as the top layer, each contributing to the robustness and versatility of the LLM. The processor 203 is configured to employ the transformer algorithm 201A on the integrated dataset to extract a plurality of domain-specific textual insights.

The processor 203 is configured to utilize the domain-specific textual insights to execute one or more business tasks. The processor 203 is configured to present both the domain-specific textual insights and the executed business tasks on a user interface.

The communication interface 205 is used for handling API requests. In an embodiment, the search engine database 107 supplies the real-time digital dataset in response to said API requests. In an embodiment, the processor 203 includes a Retrieval-Augmented Generation (RAG) model 203B for processing the domain-focused dataset, and the real-time digital data stream and applying a domain-specific answer logic within the LLM. In an embodiment, the processor 203 is configured to manage high request volumes through a microservices architecture, utilizing containerization with Docker and orchestration with Kubernetes for enhanced performance and scalability.

According to some embodiments, the transformer algorithm 201A may be embodied in the memory 201. The processor 203 may retrieve computer program code instructions that may be stored in the memory 201 for the execution of computer program code instructions, which may be configured for constructing the domain-specific LLM.

In an embodiment, the LLM demonstrates fluency across a spectrum of languages and dialects, enabling seamless cross-cultural interactions and broadening the applicability of the model in global business contexts. The LLM is equipped with a Retrieval-Augmented Generation approach, incorporating an external datastore that empowers the model to retrieve and integrate real-time, pertinent information into its output, thereby maintaining the relevance and currency of its responses. Further, the LLM is developed with an inherent ethical framework and a commitment to inclusivity, ensuring that the model upholds fairness, integrity, and respect for all users and stakeholders across its applications. The LLM is then applied to automate complex business functions such as journalism and customer service, leveraging its domain-specific insights to enhance operational efficiency and user engagement. The LLM is deployed for automated news composition, condensing articles, verifying content, identifying trends, personalizing content, transcribing interviews, and authenticating news from social media, thereby revolutionizing the media and information sectors. In an embodiment, the LLM is utilized for transforming the online marketplace experience, including automated client support, vendor integration, product description optimization, market analysis, risk evaluation, personalized suggestions, communication facilitation, and customer acquisition strategies. The LLM is employed for cross-language content creation, transcending language barriers to produce and translate content, thereby expanding the reach and accessibility of information. In an embodiment, the LLM is leveraged for strategic supplier and customer outreach, enhancing business growth and market penetration through targeted and intelligent engagement. Further, the LLM is refined through a feedback-driven process, incorporating user insights to continually enhance the model's performance and relevance. The LLM includes mechanisms for performance oversight, utilizing advanced monitoring tools to ensure the model operates at peak efficiency and effectiveness. In an embodiment, the LLM is designed with scalability assurance, featuring an infrastructure capable of adapting to increased user interactions and data processing demands without compromising performance. The LLM is attuned to the user pulse, employing behavior analysis and user surveys to maintain alignment with user needs and preferences. In an embodiment, the LLM is evaluated using efficiency barometers, monitoring speed, and resource utilization to ensure the model delivers prompt and resource-efficient responses. In an embodiment, the LLM is enhanced through user interactions, periodic retraining, a structured feedback loop, technical synergy with existing systems, process alignment with business workflows, and the application of accuracy metrics to maintain high standards of performance. Further, the LLM incorporates API rate limiting to ensure equitable resource distribution and protect the system from potential abuse or overload. In an embodiment, the LLM supports a multi-tenancy architecture, ensuring data isolation and security for each user or client within a shared system environment.

The processor 203 may be embodied in a number of different ways. For example, the processor 203 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field-programmable gate array), a microcontroller unit (MCU), a hardware accelerator, a special-purpose computer chip, or the like. As such, in some embodiments, the processor 203 may include one or more processing cores configured to perform independently. A multi-core processor may enable multiprocessing within a single physical package. Additionally, or alternatively, the processor 203 may include one or more processors configured in tandem via the bus to enable independent execution of instructions, pipelining, and/or multithreading.

Additionally, or alternatively, the processor 203 may include one or more processors capable of processing large volumes of workloads and operations to provide support for big data analysis. In an example embodiment, the processor 203 may be in communication with the memory 201 via a bus for passing information to the system 101. The memory 201 may be non-transitory and may include, for example, one or more volatile and/or non-volatile memories. In other words, for example, the memory 201 may be an electronic storage device (for example, a computer-readable storage medium) comprising gates configured to store data (for example, bits) that may be retrievable by a machine (for example, a computing device like the processor 203). The memory 201 may be configured to store information, data, content, applications, instructions, or the like, to enable the processor 203 to carry out various functions in accordance with an example embodiment of the present disclosure. For example, the memory 201 may be configured to buffer input data for processing by the processor 203. As exemplarily illustrated in FIG. 2, the memory 201 may be configured to store instructions for execution by the processor 203. As such, whether configured by hardware or software methods, or by a combination thereof, the processor 203 may represent an entity (for example, physically embodied in circuitry) capable of performing operations according to an embodiment of the present disclosure while configured accordingly. Thus, for example, when the processor 203 is embodied as an ASIC, FPGA, or the like, the processor 203 may be specifically configured hardware for conducting the operations described herein. Alternatively, as another example, when the processor 203 is embodied as an executor of software instructions, the instructions may specifically configure the processor 203 to perform the algorithms and/or operations described herein when the instructions are executed. However, in some cases, the processor 203 may be a processor-specific device (for example, a mobile terminal or a fixed computing device) configured to employ an embodiment of the present disclosure by further configuration of the processor 203 by instructions for performing the algorithms and/or operations described herein. The processor 203 may include, among other things, a clock, an arithmetic logic unit (ALU), and logic gates configured to support the operation of the processor 203.

In some embodiments, the processor 203 may be configured to provide Internet-of-Things (IoT) related capabilities to users of system 101, where the users may be a viewer, a spectator, and the like. The system 101 may be accessed using the communication interface 205. The communication interface 205 may provide an interface for accessing various features and data stored in the system 101. For example, the communication interface 205 may comprise an I/O interface which may be in the form of a GUI, a touch interface, a voice-enabled interface, a keypad, and the like.

In an embodiment, the present system is adaptable for continuous, on-the-fly learning where the LLM may update its knowledge base without the need for retraining cycles. This could involve online learning algorithms that adapt to new data in real-time. In an embodiment, the present system integrates an explainable AI (XAI) into the LLM, allowing it to provide justifications for its decisions or insights. This could involve novel techniques for tracing the decision-making process within transformer models. In an embodiment, the present system leverages decentralized data sources and federated learning to train and update the LLM while preserving privacy and data security. Further, the present system creates a framework where the LLM can learn from human feedback collaboratively, adjusting its models based on expert input through an interactive interface. In an embodiment, the present system is configured to transfer knowledge between different domain-specific LLMs, allowing for more efficient learning and reducing the need for large domain-specific datasets. In an embodiment, the present system introduces novel NLU techniques that allow the LLM to understand and process complex linguistic constructs such as idioms, sarcasm, and implicit context. In an embodiment, the present system combines neural network approaches with symbolic reasoning to create an LLM that can handle abstract, logical, and knowledge-based tasks more effectively. In an embodiment, the present system is configured to reduce the computational and energy footprint of LLMs, making them more sustainable and accessible for deployment in resource-constrained environments. In an embodiment, the present system dynamically adjusts its data processing and storage practices based on changing privacy laws and regulations, ensuring compliance while maintaining model performance. In an embodiment, the present system provides the LLM with a self-modifying architecture that can reconfigure its neural network structure in response to the type of data being processed or the specific task at hand. In an embodiment, the present system integrates the LLM with cognitive architectures that mimic human problem-solving and reasoning processes, enabling the model to handle complex, multi-step tasks with human-like flexibility. In an embodiment, the present system leverages quantum computing algorithms to improve the processing capabilities of LLMs, potentially leading to breakthroughs in speed and efficiency for complex language tasks. Further, the present system incorporates biologically inspired learning algorithms, such as those based on neural plasticity or evolutionary principles, to create LLMs that learn and adapt in ways more akin to natural intelligence. In an embodiment, the present system integrates affective computing techniques to enable the LLM to understand and generate language that appropriately conveys emotions, enhancing human-computer interaction. In an embodiment, the LLM of the present system can understand and perform tasks with little to no training data, using novel zero-shot or few-shot learning techniques. In an embodiment, the present system utilizes blockchain technology to ensure the integrity and traceability of the data used for training and operating the LLM, enhancing transparency and trust in AI-generated content. In an embodiment, the present system utilizes Blockchain technology to track the origin and transformations of datasets used in training the LLM, ensuring transparency and accountability in the model's development. Blockchain can maintain a record of different versions of the LLM, including updates and changes over time, allowing for better management and reproducibility of results. When sharing insights generated by the LLM with third parties, blockchain can ensure that the data is not tampered with and that all parties can trust the shared insights. Blockchain can be used to establish and verify the ownership of AI-generated content, protecting the intellectual property rights of content creators. In scenarios where federated learning is used, blockchain can help manage and secure the decentralized training process, ensuring that contributions from different nodes are properly accounted for. Blockchain can provide an immutable audit trail for decisions made by the LLM, which is particularly important in regulated industries where decision-making processes need to be documented and reviewed. In an embodiment, the present system is created where the LLM can act as a personalized AI assistant that adapts to individual user preferences, learning styles, and interaction patterns over time. In an embodiment, the present system detects and mitigates biases in LLMs, incorporating ethical considerations into the model's training and decision-making processes. In an embodiment, the present system creates lightweight LLMs that maintain high performance while being deployable on edge devices with limited computational resources. Further, the present system combines the LLM with virtual or augmented reality to create interactive and immersive language learning environments that respond to user actions and speech in real-time. In an embodiment, the present system implements predictive maintenance algorithms within the LLM infrastructure to anticipate and prevent system failures or performance degradation before they occur. In an embodiment, the present system is configured for distilling knowledge from high-resource languages to low-resource languages within the LLM, enhancing the model's performance across a wider range of languages. In an embodiment, the present system provides mechanisms for regulating AI-generated content, ensuring compliance with legal standards and ethical guidelines while maintaining the creative capabilities of the LLM. Additionally, the present system explores the integration of LLMs with neural interfaces, enabling direct brain-computer communication for language generation and comprehension tasks.

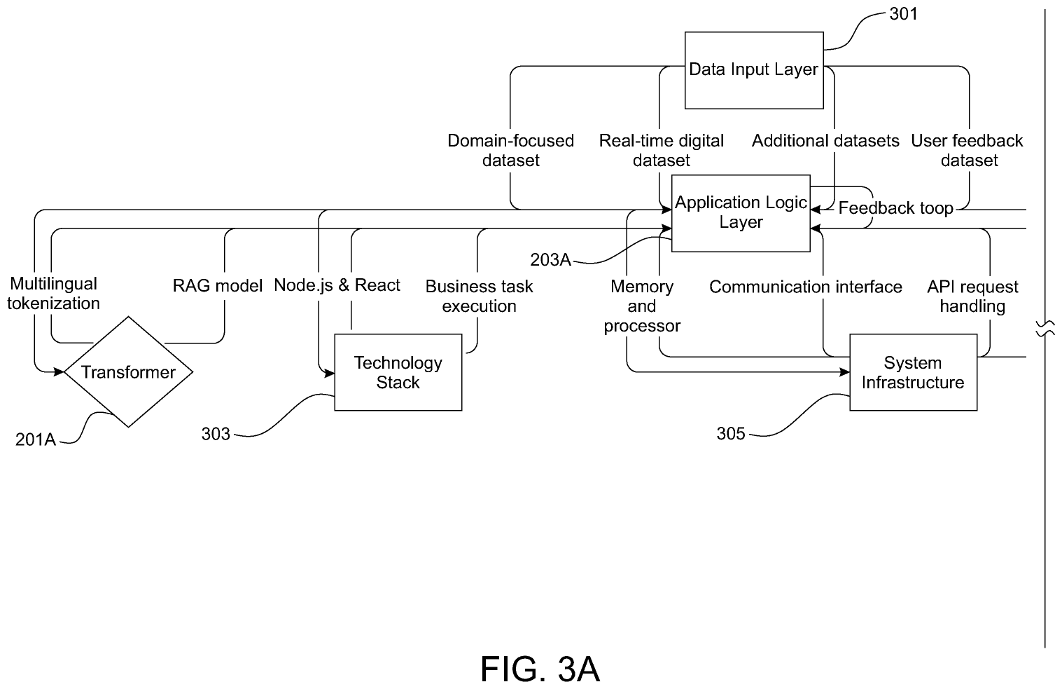

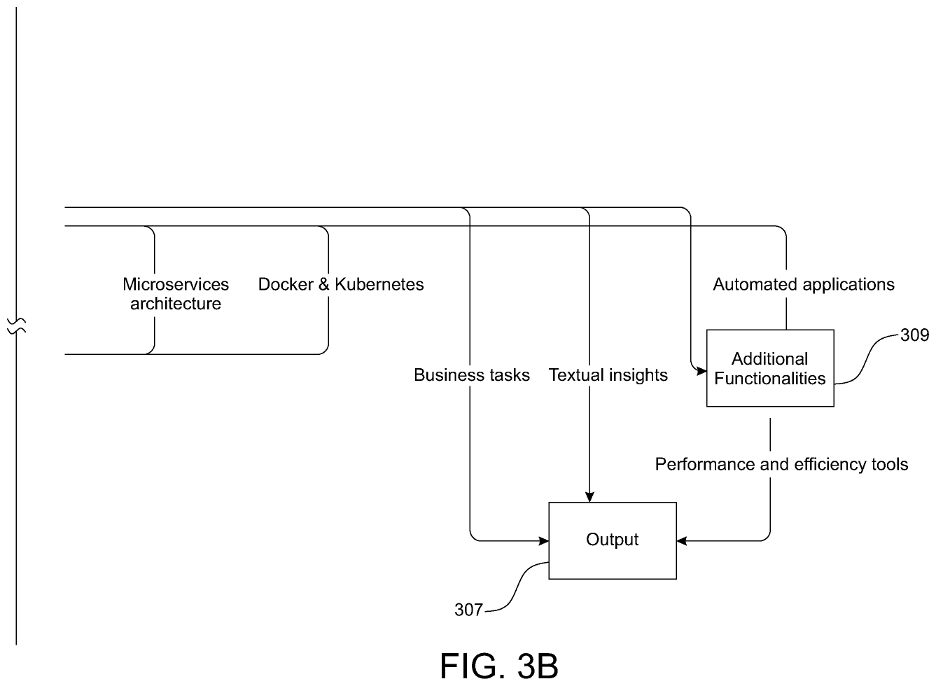

FIGS. 3A-3B illustrate operational flowcharts of the present system and method, in accordance with one or more example embodiments. FIG. 3 is explained in conjunction with FIGS. 1-2. In various embodiments, the present system may include a data input layer 301, application logic layer 203A, transformer algorithm 201A, a technology stack 303, a system infrastructure 305, an output component 307, and additional functionalities block 309. In the implementation, the data input layer 301 provides a domain-focused dataset, real-time digital dataset, additional datasets, and user feedback dataset related to various applications or business tasks to the application logic layer 203A. The application logic layer 203A transmits the datasets received from the data input layer 301 to the system infrastructure 305 which includes various components such as memory, processor, communication interface, API request handling component, microservices architecture, docker, and Kubernetes to perform various operations as mentioned in the FIG. 1-2. The transformer algorithm 201A utilizes multilingual tokenization and the RAG model to provide linguistic precision. The technology stack 303 executes business tasks by utilizing one or more of Node.js and React frameworks. After processing the datasets through the application logic layer 203A, transformer algorithm 201A, technology stack 303, and the system infrastructure 305, the output component 307 is used to execute the business tasks and present the textual insights. The additional functionalities block 309 automates the applications based on the provided datasets and provides performance and efficiency tools to the output component 307.

According to an embodiment herein, the system is meticulously designed to craft scalable business applications. With its unique integration of the application logic layer, the present system adeptly addresses the inherent challenges faced by contemporary LLMs, especially when it comes to interfacing with vast, diverse data assets. Accordingly, one advantage of the present system is it delivers real-time and context-aware solutions.

According to an exemplary embodiment of the present system, the data input layer 301 is enriched with data tailored to various business applications such as a media network (BNN News) and a B2B marketplace (Procurenet). By harnessing niche datasets and integrating cutting-edge technologies like SERP API and Hugging Face's transformers library, the present system ensures unparalleled linguistic precision. Typically, the SERP API, which stands for Search Engine Results Page API, allows developers to retrieve search engine results programmatically. SERP API provides an interface to interact with search engines, such as Google, Bing, or Yahoo, and obtain the data typically displayed on a search engine results page.

The application logic layer 203A includes various application modules tailored for specific business tasks, such as automated news composition for BNN News or automated client support for Procurenet. Each module has predefined logic and sequences to ensure the AI understands and executes business tasks correctly. This layer also includes API integration, allowing the model to interact with databases, CRM systems, and other software.

In an exemplary embodiment, the output component 307 may be a user interface to provide human-AI interaction. This output component 307 is dedicated to the user, offering intuitive interfaces, whether chat or voice-based. Furthermore, with integrated user controls and a feedback loop, the present system is always learning, and improving.

According to an embodiment herein, the present system may source domain-centric datasets, like BNN's vast archive of news articles, and fine-tune the LLM of the present system. In an embodiment, the transformer algorithm may be based on Hugging Face's Transformers library to further amplify this expertise, ensuring the LLM is always a step ahead.

According to an embodiment herein, the present system may aggregate diverse language datasets and leverage Hugging Face's multilingual models to ensure the LLM speaks the language of the world.

Every task is unique, and the LLM of the present system recognizes that. By acquiring task-specific datasets and utilizing specialized training methods, the LLM excels in every task it undertakes.

According to an embodiment herein, the present system may integrate databases and knowledge graphs, transforming structured data into easily digestible textual formats, ensuring the LLM always has a holistic understanding.

According to an embodiment herein, the present system may curate datasets and set training goals that emphasize fairness and ethical considerations, ensuring every interaction is safe and unbiased.

The present disclosure further discloses a business application on the media network (BNN). From automated news composition, trend identification, and content verification, to user-tailored content and interview transcription, BNN has been transformed into a powerhouse of efficiency and innovation. In this example, the LLM of the present system automates news composition and revolutionizes news writing, especially for data-driven narratives. In implementation, the structured data inputs and advanced models like GPT-3 or GPT-Neo from Hugging Face's Transformers library are leveraged. This synergy ensures real-time, high-quality news composition. This leads to a quantum leap in news production speed, unparalleled consistency, and expanded topical coverage.

In another example, the LLM of the present system condenses news and crafts concise versions of extensive articles for the time-conscious reader. The present system deploys algorithms that distill the essence of lengthy articles, presenting a condensed yet comprehensive version. This feature provides a “quick read” option, ensuring readers are always in the know, even on the go.

In another example, the LLM of the present system verifies the content and maintains the integrity and reliability of published content. To do this, the present system utilizes datasets of verified facts and information. Cross-reference new content against these datasets to highlight potential inaccuracies or misrepresentations. The present system implements this by integrating a signal to fetch real-time data from SERPAPI. This tool scrapes search engine results pages, providing a wealth of current data. By comparing BNN's content with the top-ranking news articles or sources on search engines, the platform can further validate the accuracy and timeliness of its news. This serves as an additional layer of verification, ensuring the news aligns with the prevailing narratives on major search engines. The benefits of this feature include but are not limited to upholding the trustworthiness of the platform, and ensuring readers receive accurate and timely information. Further, it minimizes the spread of misinformation by cross-referencing with multiple reputable sources. Lastly, it leverages SERPAPI's extensive data to stay aligned with real-time, global news trends.

In another example, the LLM of the present system is used to identify trends and enable the media network to stay ahead of competitors.

The present disclosure further discloses another business application of the invention on the B2B marketplace such as Procurenet. Automated client support, vendor integration, product description optimization, market dynamics analysis, and customer acquisition are just a few areas where the present system can be applied. The application of the present system in the B2B marketplace elevates the online marketplace experience. With a refined foundational LLM, Procurenet is not just an online marketplace; it is a symphony of efficiency, precision, and user-centricity. Further, the present system provides a client support system that is not just responsive but also intelligent. Further, it addresses client queries with precision, drawing from a rich database of FAQs. Furthermore, the present system delivers in-depth product insights, making information access instantaneous and intuitive. Additional advantages of the present system include but are not limited to 1) semantic analysis-driven issue detection and resolution, ensuring a seamless user experience; 2) streamlining the vendor onboarding process using the LLM; 3) navigating vendors through the platform's registration process, ensuring accurate and timely data input; 4) automatically validating vendor certifications against recognized databases or digital certification bodies, ensuring authenticity; 5) providing real-time explanations on platform policies, ensuring vendors adhere to stipulated guidelines; 6) enhancing the clarity and comprehensiveness of product descriptions; 7) implementing templates for product descriptions ensuring uniformity across listings and employing text-generation models from Hugging Face to enhance and optimize product descriptions automatically; 8) using the model to automatically fill gaps in descriptions, adding vital data that might be missing; 9) suggesting or generating relevant graphics or charts that can supplement the textual descriptions.

In the ever-evolving marketplace, staying updated with real-time market dynamics is crucial. The framework of the present system is designed to ensure businesses are always a step ahead. Further, the present system 1) detects and capitalizes on emerging market trends; 2) anticipates and mitigates potential market disruptions; 3) ensures platform integrity by assessing vendor reliability; 4) makes informed decisions by understanding global commodity trends; 5) forecasts potential high-risk situations; 6) understands user behavior to enhance their platform experience; 7) enhances user experience by suggesting relevant products; 8) expedites common negotiations; 9) fosters positive interactions between buyers and sellers; 10) expands the supplier base; 11) drives platform growth by acquiring new customers; and 12) continuously refines acquisition processes.

Beyond the standard functionalities of traditional LLMs, the present system boasts a sophisticated application logic layer. The application logic layer is meticulously designed to ensure that AI not only understands but also behaves in alignment with business-specific logic, making it a game-changer in the realm of business applications.

In today's interconnected digital ecosystem, the present system shines with its seamless interoperability. It effortlessly integrates with a myriad of business software, databases, and other essential tools, ensuring a cohesive and streamlined operational experience.

In a world where businesses are in a constant state of evolution, the present system's framework is future-ready. It is architected to easily accommodate new modules, features, and functionalities, ensuring businesses remain agile and adaptive.

With the present system at the helm, businesses can significantly reduce manual interventions. The power of automation, combined with the precision of the system, guarantees optimal outcomes, every single time.

In the age of big data, storage is paramount. The present system partners with cloud behemoths like AWS and Google Cloud, ensuring vast datasets are stored securely and are readily accessible.

The heart of any LLM is its computational prowess. The present system ensures robust provisions of GPU/TPU, catering to the intensive demands of training tasks.

In a real-time world, connectivity is king. The present system prioritizes establishing a high-bandwidth, resilient network, ensuring instantaneous data exchanges and interactions.

The present system believes in the power of specialized knowledge. Collaborations with domain experts and specialists ensure access to niche, domain-focused datasets, enriching the model's knowledge base.

Data is only as good as its quality. The present system employs advanced Python libraries and tools to sanitize data, ensuring its purity, consistency, and relevance.

The present system places its trust in renowned platforms like TensorFlow, ensuring the model benefits from the latest advancements in the field.

The journey begins with modest learning rates, laying a solid foundation. As training progresses, the learning rate is incrementally intensified, all while preserving the base knowledge and ensuring optimal learning.

QLora is harnessed to further optimize our foundational layer LLM. This fine-tuning ensures that the model achieves unparalleled domain-specific proficiency and performance. Additionally, the integration of Hugging Face's Transformers library alongside TensorFlow opens doors to a vast repository of cutting-edge pre-trained NLP models.

The present system incorporates validation sets, meticulously overseeing model performance, ensuring it is on the right track, and taking corrective measures against potential overfitting.

With platforms like TensorBoard, the present system keeps a vigilant eye on the LLM's performance, ensuring it is always operating at its peak.

The present system believes in the power of feedback. Regular user feedback is assimilated, and the model is iteratively refined, ensuring it always meets and exceeds user expectations.

As user traffic grows, the present system is prepared. The infrastructure is engineered to handle surges in user interactions, ensuring response times remain swift and efficient, irrespective of the load.

In the dynamic landscape of technology, stagnation is not an option. The present system embodies this ethos, thriving on a foundation of continuous learning and evolution. Through a meticulous blend of periodic retraining, logic enhancements, and invaluable feedback from our user community, the present system ensures it not only keeps pace with but also leads the charge in technological advancements.

To perpetually refine and ensure the LLM remains cutting-edge, even post-deployment.

Harness the power of every interaction, using it as a learning opportunity to refine and enhance the model's responses.

Like clockwork, schedule retraining sessions, ensuring the model is always updated with the latest trends, data, and insights.

Through a robust system, encourage users to voice concerns, report issues, or even provide suggestions, all of which serve as the bedrock for continuous refinement. Usage: This iterative approach ensures that the present system remains ever-relevant, consistently accurate, and is always on an upward trajectory of performance enhancement.

The present system does not just complement the initial foundational layer LLM models; it elevates it. By infusing domain-specific expertise, multilingual capabilities, specialized training modules, structured knowledge assimilation, and a strong ethical foundation, the present system has significantly amplified open-source foundational capabilities.

To harmoniously integrate the LLM with platforms like BNN News and Procurenet, enhancing their existing systems. Implementation:

The present system crafts APIs and ensures data formats are in sync, paving the way for fluid data exchanges between the LLM and legacy systems.

The present system intertwines the LLM's capabilities with existing workflows, ensuring it augments current operations without causing any disruptions. Usage: This integration approach ensures that the adoption of the present system into existing ecosystems not only enhances functionalities but also elevates overall operational efficiency.

The present system is more than just code. It is a meticulously designed blueprint for seamless integration, scalability, and future readiness. From the foundational aspects like infrastructure and data collation to the nuances of continuous development and deployment strategies, every facet of the present system is crafted for excellence.

Accordingly, one objective of the present invention is to maintain a vigilant eye on the LLM's performance, ensuring it consistently aligns with the desired benchmarks. The present system deploys metrics such as precision, recall, and F1 score, especially for critical tasks like fact-checking. The present system regularly taps into user sentiment through surveys and behavior analysis, ensuring services like customer support are always top-notch. The present system continuously monitors the LLM's speed and resource utilization, especially for demanding tasks. These metrics offer a tangible measure of the present system's performance, spotlighting areas of excellence and potential improvement.

The present system's commitment to excellence is unwavering. Through a comprehensive suite of accuracy metrics, user satisfaction indices, and efficiency barometers, we maintain a relentless focus on refining and enhancing the present system's performance, ensuring it always meets and often exceeds the gold standards.

Designed with an eye on the future, the present system (which may commercialized as epiphany) is primed for growth. Leveraging the power of cloud deployment, the flexibility of containerization, and the efficiency of load balancing, the present system promises stellar performance, irrespective of the surge in data volumes or user interactions. The present system is not merely another LLM in the market; it represents a seismic shift in the realm of Language Learning Models.

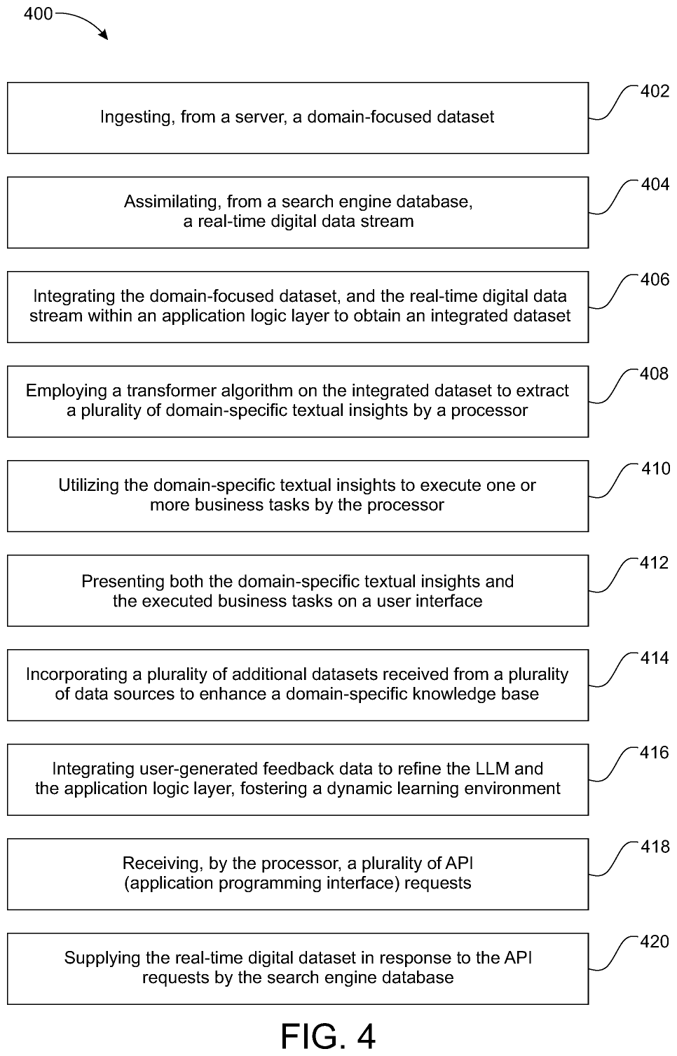

FIG. 4 is a flowchart of a computer-implemented method 400 for constructing a domain-specific language learning model (LLM), in accordance with one or more example embodiments. FIG. 4 is explained in conjunction with FIGS. 1-3. The method 400 includes a step 402 of ingesting, from a server, a domain-focused dataset. The method 400 includes a step 404 of assimilating, from a search engine database, a real-time digital data stream. The method 400 includes a step 406 of integrating the domain-focused dataset, and the real-time digital data stream within an application logic layer to obtain an integrated dataset. In an embodiment, the application logic layer is constructed using contemporary development frameworks, such as Node.js and React, and is deployable across major cloud platforms for optimal scalability and reliability. The method 400 includes a step 408 of employing a transformer algorithm on the integrated dataset to extract a plurality of domain-specific textual insights by a processor. In an embodiment, the transformer algorithm is adaptable to process multilingual datasets by applying one or more advanced tokenization techniques to generate the domain-specific insights across a plurality of languages. In an embodiment, the transformer algorithm incorporates a Retrieval-Augmented Generation (RAG) approach, enabling the LLM to dynamically integrate pertinent real-time information into its output, thereby enhancing the relevance and accuracy of its responses. The method 400 includes a step 410 of utilizing the domain-specific textual insights to execute one or more business tasks by the processor. The method 400 includes a step 412 of presenting both the domain-specific textual insights and the executed business tasks on a user interface. The method 400 further includes a step 414 of incorporating a plurality of additional datasets received from a plurality of data sources to enhance a domain-specific knowledge base. Further, the method 400 includes a step 416 of integrating user-generated feedback data to refine the LLM and the application logic layer, fostering a dynamic learning environment. The method 400 then includes a step 418 of receiving, by the processor, a plurality of API (Application programming interface) requests. Further, the method 400 includes a step 420 of supplying the real-time digital dataset in response to the API requests by the search engine database.

The objective of the present method is to create a domain-specific language learning model (LLM) with an application logic layer. This invention caters to the imperative requirement of seamlessly integrating real-time and domain-specific data, thereby presenting a Language Learning Model (LLM) that is not only more effective but also highly applicable across diverse business sectors. The proposed invention goes beyond conventional LLM capabilities, providing a distinct competitive edge in the dynamic landscape of business AI applications.

It will be understood that each block of the flow diagram of the methods 400 may be implemented by various means, such as hardware, firmware, processor, circuitry, and/or other communication devices associated with the execution of software including one or more computer program instructions. For example, one or more of the procedures described above may be embodied by computer program instructions. In this regard, the computer program instructions that embody the procedures described above may be stored by the memory 201 of the system 101, employing an embodiment of the present disclosure and executed by the processor 203. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flow diagram blocks.

Accordingly, blocks of the flow diagrams support combinations of means for performing the specified functions and combinations of operations for performing the specified functions for performing the specified functions. It will also be understood that one or more blocks of the flow diagram, and combinations of blocks in the flow diagram, may be implemented by special-purpose hardware-based computer systems that perform the specified functions, or combinations of special-purpose hardware and computer instructions.

Further using the methods described in the accompanying embodiments of the flowchart shown in FIG. 4, which implements the various functionalities of the system 101 described in FIG. 2, the domain-specific language learning model (LLM) is efficiently constructed.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method for constructing a domain-specific language learning model (LLM), comprising:
ingesting, from a server, a domain-focused dataset;
assimilating, from a search engine database, a real-time digital data stream;
integrating the domain-focused dataset, and the real-time digital data stream within an application logic layer to obtain an integrated dataset;
employing, by a processor, a transformer algorithm on the integrated dataset to extract a plurality of domain-specific textual insights;
utilizing, by the processor, said domain-specific textual insights to execute one or more business tasks; and
presenting both the domain-specific textual insights and the executed business tasks on a user interface.

2. The method of claim 1, further comprising a step of incorporating a plurality of additional datasets received from a plurality of data sources to enhance a domain-specific knowledge base.

3. The method of claim 1, further comprising a step of integrating user-generated feedback data to refine the LLM and the application logic layer, fostering a dynamic learning environment.

4. The method of claim 1, wherein the transformer algorithm is adaptable to process multilingual datasets by applying one or more advanced tokenization techniques to generate the domain-specific insights across a plurality of languages.

5. The method of claim 1, wherein the application logic layer is constructed using contemporary development frameworks, such as Node.js and React, and is deployable across major cloud platforms for optimal scalability and reliability.

6. The method of claim 1, wherein the transformer algorithm incorporates a Retrieval-Augmented Generation (RAG) approach, enables the LLM to dynamically integrate pertinent real-time information into its output, thereby enhancing the relevance and accuracy of its responses.

7. The method of claim 1, further comprises: receiving, by the processor, a plurality of API requests.

8. The method of claim 1, further comprises: supplying, by the search engine database, the real-time digital dataset in response to the API requests.

9. A system for constructing a domain-specific language learning model (LLM), comprising:
a memory storing computer-executable instructions; and
a processor configured to execute said computer-executable instructions to:
ingest a domain-focused dataset;
assimilate a real-time digital data stream;
integrate the domain-focused dataset, and the real-time digital data stream within an application logic layer to obtain an integrated dataset;
employ a transformer algorithm on the integrated dataset to extract a plurality of domain-specific textual insights;
utilize the domain-specific textual insights to execute one or more business tasks; and
present both the domain-specific textual insights and the executed business tasks on a user interface.

10. The system of claim 9, further comprising:
a communication interface for handling API requests; and
a search engine database to supply the real-time digital dataset in response to said API requests.

11. The system of claim 9, wherein the processor comprises a Retrieval-Augmented Generation (RAG) model for processing the domain-focused dataset, and the real-time digital data stream and applying a domain-specific answer logic within the LLM.

12. The system of claim 9, wherein the processor is configured to manage high request volumes through a microservices architecture, utilizing containerization with Docker and orchestration with Kubernetes for enhanced performance and scalability.

13. A non-transitory computer-readable medium containing code or instructions that, upon execution, enable a processor to:
ingest a domain-focused dataset;
assimilate a real-time digital data stream;
integrate the domain-focused dataset, and the real-time digital data stream within an application logic layer to obtain an integrated dataset;
employ a transformer algorithm on the integrated dataset to extract a plurality of domain-specific textual insights;
utilize the domain-specific textual insights to execute one or more business tasks; and
present both the domain-specific textual insights and the executed business tasks on a user interface.

14. The non-transitory computer-readable medium of claim 13, further containing code or instructions that, upon execution, enable a processor to assimilate a plurality of additional datasets from a plurality of data sources.

15. The non-transitory computer-readable medium of claim 13, wherein the plurality of data sources comprising databases, data warehouses, data lakes, and other structured data sources accessible via API.

16. The non-transitory computer-readable medium of claim 13, further containing code or instructions that, upon execution, enable a processor to process an extensive multilingual dataset within the application logic layer, applying a suite of multilingual tokenization techniques to generate insightful texts with enhanced significance and precision.

17. The non-transitory computer-readable medium of claim 13, further containing code or instructions that, upon execution, enable a processor to integrate a feedback dataset from users to refine the LLM and the application logic layer.

18. The non-transitory computer-readable medium of claim 13, wherein the feedback dataset comprising user inputs related to the performance and effectiveness of the LLM and the application logic layer.

19. The non-transitory computer-readable medium of claim 13, further comprising code or instructions that, when executed, enable a processor to utilize development frameworks and tools, such as Node.js for backend services and React for frontend components, to construct the application logic layer, ensuring a responsive and scalable deployment across cloud platforms.

20. The non-transitory computer-readable medium of claim 13, further comprising code or instructions that, when executed, enable a processor to implement a Retrieval-Augmented Generation (RAG) approach within the transformer algorithm, facilitating the integration of real-time, relevant information into the LLM's output for enhanced contextual accuracy.
